(19) United States
(12) Patent Application Publication
(10) Pub. No.: US 2011/0179463 A1
(43) Pub. Date: Jul. 21, 2011

(54) SELECTION OF A DATA STREAM

(75) Inventors: Nathalie Brugeas, Maisons Alfort (FR); Dominique Thome, Neuilly Sur Seine (FR); Lucie Degraeve, Lyon (FR); Stéphane Vernet, Jouy En Josas (FR); Lydie Du Basty, Paris (FR); François Rondeau, Sceaux (FR)

(73) Assignee: France Telecom, Paris (FR)

(21) Appl. No.: 13/120,447

(22) PCT Filed: Sep. 30, 2009
(86) PCT No.: PCT/FR2009/051855

§ 371 Date: Mar. 23, 2011

(30) Foreign Application Priority Data
Sep. 30, 2008 (FR) 0856616

(51) Int. Cl. H04N 7/173

(52) U.S. Cl. 725/110

(57) ABSTRACT

In order to assist the selection of a data stream to be played back on a receiver device from a plurality of data streams received by the receiver device, a plurality of data streams are received in a processor unit simultaneously with auxiliary data respectively associated with said data streams. Then, on the basis of the received auxiliary data, information for assisting selection of what is to be displayed for each data stream is determined. Thereafter, the data streams are linked with the respectively determined selection assistance information. These linked data streams are then transmitted to the receiver device.

The present invention relates to receiving a plurality of data streams and more particularly to selecting a data stream from that plurality of data streams in a receiver user device.

It is a simple matter to receive a plurality of data streams from a plurality of broadcast sources in a receiver device via a transmission network, be it the Internet, a radio network, a digital network, or a mobile communications network. For example, a computer connected to the Internet is able to receive data streams from a plurality of radio sources and is able to play back the sound track broadcast by the radio source that has been selected by the user of the computer. The same applies to audiovisual contents and to purely visual contents. An audio or audiovisual content is played back by means of software known as a ‘player’ reading data received in the audio or audiovisual streams.

On a receiver device of this type adapted to receive a plurality of data streams, the user is able to select the data stream to be accessed, i.e. the data stream that the user desires to have played back on the terminal. However, this selection relies entirely on an identifier of the broadcast source of the required data stream.

Thus when a user is looking for a program that might be of interest, the user may either change broadcast source, i.e. “zap” from radio or television channel to channel, or else refer to a list of programs offered by the various channels available, this list being accessible elsewhere.

This approach is not user friendly and it can sometimes take a long time to find a broadcast source, especially if the user does not have access to the list of programs broadcast by the various sources.

The present invention aims to improve on this situation.

A first aspect of the present invention proposes a method of assisting the selection of a data stream to be played back in a receiver device from a plurality of data streams received by the receiver device, the receiver device including a screen, said method including the following steps executed in a processor unit:

a) simultaneously receiving a plurality of data streams and auxiliary data respectively associated with said data streams;

b) determining on the basis of the received auxiliary data selection assistance information to be displayed for each data stream;

c) linking the data streams with the selection assistance information respectively determined; and

d) transmitting to the receiver device the data streams linked to said selection assistance information.

By means of such features, it is possible to supply to the receiver device data streams linked to the selection assistance information that has been determined for it.

A data stream linked to the selection assistance information may be transmitted in the form of either a single stream or a plurality of streams. With a plurality, it is easier to recover the selection assistance information in the receiver device.

The transmitted selection assistance information linked to the data streams is intended to be displayed simultaneously in respective different parts of the screen of the receiver device for the data streams.

This transmitted selection assistance information advantageously allows the user of the receiver device to be provided with an efficient and user-friendly video interface. Under such conditions, the user is able to view simultaneously selection assistance information respectively associated with the various data streams.

The received data streams may be the result of preselection of preferred or favorite radio stations or television channels of a user of the receiver device, for example. These streams may be received via any type of transmission, notably radio transmission.

The expression “data stream” refers to any audio and/or video data stream. Thus a data stream of this kind may in particular transmit a picture, a sound track, a video, or a text.

The expression “selection assistance information” refers to any information that is associated with the data transported in the data stream, i.e. the audio and/or video content being broadcast, that is liable to assist the user in making a choice from all the received data streams. This selection assistance information may differ according to the type of media broadcast source concerned. Thus for audio data broadcast sources, such as radio stations, the selection assistance information may relate to the artist, the title of the broadcast track or the show, with or without the names of the participating artists or other personalities, or to the album, the biography of the artist or the radio presenter, photos or information relating to news about the artist, for example concert dates, etc.

To be more precise, selection assistance information is determined on the basis of auxiliary data or metadata that may be recovered directly in the respective data streams with which it is associated. This auxiliary data may also be transmitted in dedicated auxiliary data streams.

Some data streams may include auxiliary data directly, i.e. data complementary to the audio and/or video content with which it is associated. Sometimes this is not so, however, or the auxiliary data transmitted directly in the corresponding data stream is encrypted. Such data may then be recovered from a dedicated auxiliary data stream associated with the data stream concerned.

It should be noted that the processor unit may be in the receiver device. Alternatively it may be in a server, enabling the steps of the method of one implementation of the present invention to be executed in the server for a plurality of receiver devices.

The processor unit determines the selection assistance information for a data stream by selecting auxiliary data from the received auxiliary data taking account of at least one criterion specific to the auxiliary data and/or at least one criterion specific to a user profile.

The selection criteria specific to the auxiliary data itself may relate to the digital format of the data or the level of quality of the data or to monitoring the data itself in order to filter out any content deemed unacceptable.

The selection criteria specific to a user may be keywords corresponding to the favorite artists or topics of the user.

This approach enables provision of selection assistance information that is in itself acceptable and of high quality and that is furthermore highly relevant to assisting the user choose a data stream.

In one implementation of the present invention, the method further includes before the step c) the following steps executed in the processor unit for a data stream:
sending the data stream to a data stream recognition server; and
receiving from said data stream recognition server additional selection assistance information linked to said data stream.

Here the auxiliary data received from elsewhere may advantageously be complemented by supplying the data stream itself, i.e. the transmitted audio and/or video content, to a data stream recognition server, which may be a multimedia recognition server. This server may then provide a great variety of additional information to assist the user to select a data stream.

Selection assistance information may be linked with a data stream in step c as a function of semantic or temporal consistency criteria.

Thus where appropriate, after obtaining selection assistance information for each data stream, it is possible to link this selection assistance information to other data streams.

Thus the same selection assistance information may be used for different data streams in a consistent manner, for example on the basis of a semantic analysis of the selection assistance information relative to the audio and/or video content or a user profile. For example, a document relating to a type of music may be linked to a plurality of data streams that broadcast that type of music.

Auxiliary data may also be received in step a in at least one user stream dynamically associated with a data stream.

A feature of this kind allows interactivity between either all users who receive the same data stream or else users constituting a restricted group.

In one implementation of the present invention a user stream transports data that may be displayed as a moving stripe on the screen of the receiver device. This user data may be transmitted in a user stream from any terminal, for example by means of an SMS (Short Message Service) message. These user streams may also correspond to a vote relating to the broadcast audio and/or video content.

A restricted user group of this kind may correspond to a discussion forum or chat room. One example of a restricted user group is a group of persons identified as being interested in a particular topic, for example a group of fans of an artist. This approach makes it possible for each user in this group to send a user stream transporting selection assistance information relating to this topic when a data stream being broadcast relates to this topic. A user stream may thus transmit photos or concert dates of an artist within a group of fans of said artist.

The following steps may be implemented in the receiver device:

1) displaying the selection assistance information on the screen;

2) receiving a data stream selection command based on the displayed selection assistance information; and

3) playing back the selected data stream.

By means of this feature, the user may view the selection assistance information in corresponding relationship to the various streams that they may select and then make a pertinent choice quickly and easily.

A second aspect of the present invention proposes a processor unit including means adapted to implement a selection assistance method of the first aspect of the present invention.

A third aspect of the present invention proposes a receiver device including means adapted to display selection assistance information in accordance with an implementation of the present invention.

This receiver device may include a processor unit of the second aspect of the present invention.

A fourth aspect of the present invention proposes a computer including a receiver device of the third aspect of the present invention.

A fifth aspect of the present invention proposes a television set including a receiver device of the third aspect of the present invention.

A sixth aspect of the present invention proposes a radio alarm including a receiver device of the third aspect of the present invention.

A seventh aspect of the present invention proposes a radio receiver including a receiver device of the third aspect of the present invention.

An eighth aspect of the present invention proposes a GPS (Global Positioning System) entity including a receiver device of the third aspect of the present invention.

A ninth aspect of the present invention proposes a MP3 (Moving Pictures Expert Group Audio Layer 3) player including a receiver device of the third aspect of the present invention.

A tenth aspect of the present invention proposes a computer program including instructions for implementing the method of the first aspect of the present invention when that program is executed by a processor.

An eleventh aspect of the present invention proposes a storage medium storing the computer program of the seventh aspect of the present invention.

Other aspects, aims and advantages of the present invention appear on reading the description of an implementation thereof.

The invention can also be better understood with the assistance of the drawings, in which:

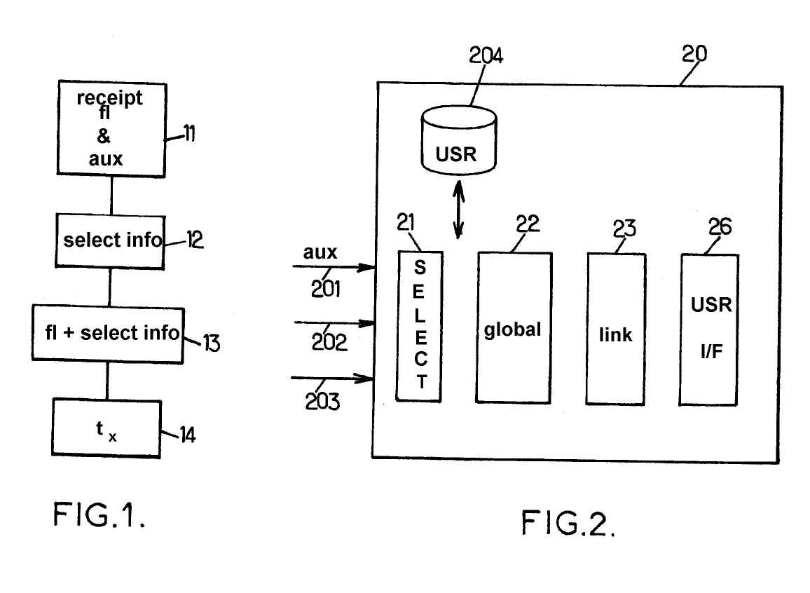

FIG. 1 shows the main steps of a method of one implementation of the present invention;

FIG. 2 shows a set of functions enabling implementation of a selection assistance method of one implementation of the present invention;

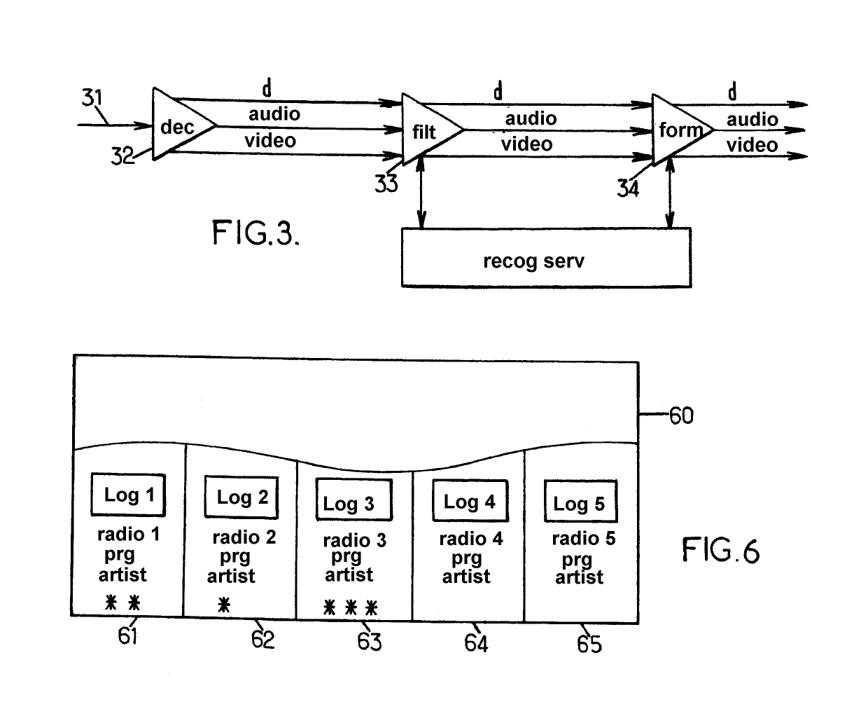

FIG. 3 shows an overall processing function of one implementation of the present invention;

FIG. 4 shows a linking function of one implementation of the present invention;

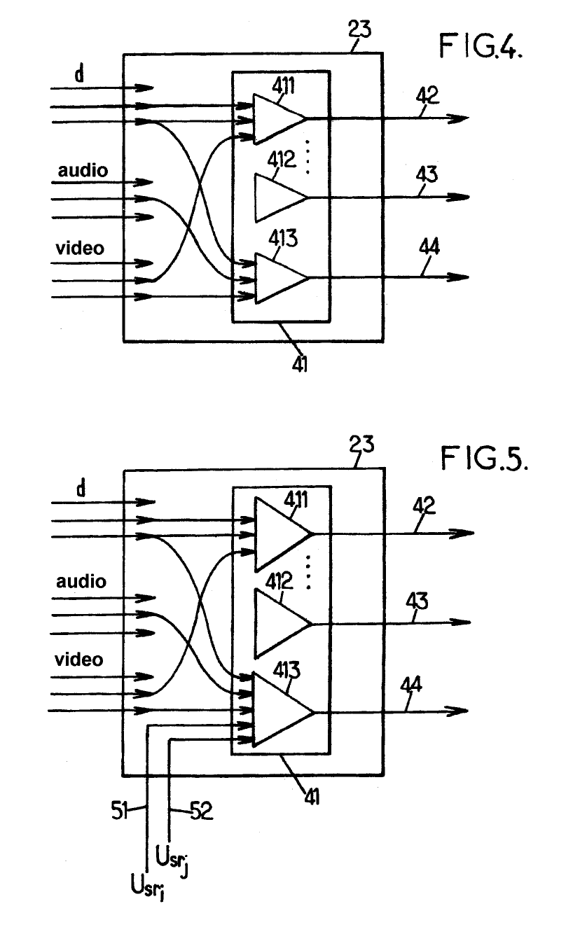

FIG. 5 shows an interactive linking function of one implementation of the present invention;

FIG. 6 shows a user interface displayed on the screen of a receiver device of one implementation of the present invention applied to radio station selection; and

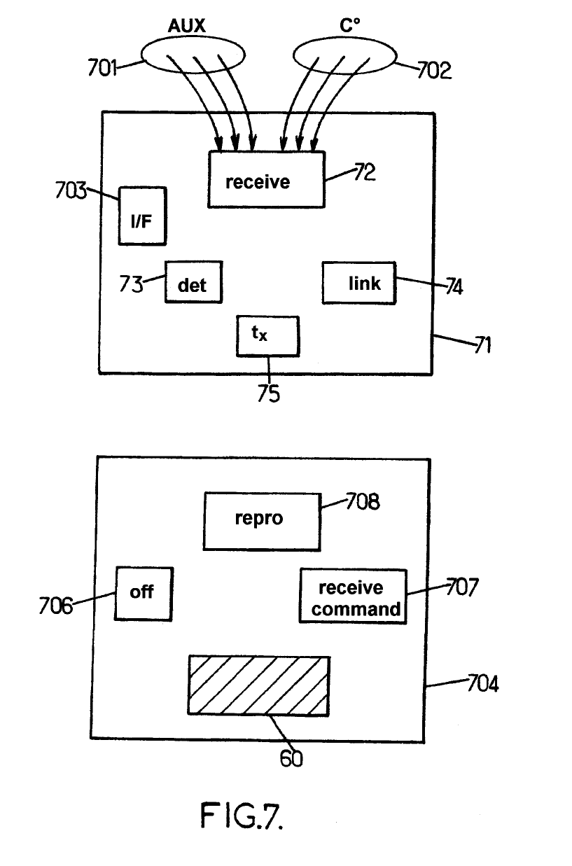

FIG. 7 shows a processor unit and a receiver device of one embodiment of the present invention.

FIG. 1 shows the main steps of a selection assistance method of one implementation of the present invention.

These steps are executed in a processor unit able to receive a plurality of data streams (also referred to as “audio and/or video content streams”) and to transmit to a receiver device data streams linked to selection assistance information. An audio and/or video data content may for example correspond to a radio broadcast, a video or a text document.

In a step 11, the processor unit receives simultaneously a plurality of data streams and auxiliary data respectively associated with those data streams. Auxiliary data associated with a data stream may be transmitted either directly in the data stream, and therefore recovered therein, or in dedicated auxiliary data streams. Auxiliary data may also be recovered in both the associated data stream and the dedicated data streams. A dedicated data stream may be sent from a source different from that sending the data stream with which the dedicated data stream is associated. No limitation is associated with the context of auxiliary data reception.

The plurality of received data streams may be the result of preselection by a user who has indicated their favorite broadcast sources beforehand.

Generally speaking, the auxiliary data may be volatile or temporary data. For a radio station, for example, this type of volatile data may indicate a broadcast name if the content currently being received corresponds to a radio show and/or a guest on that show, or a song title if the received content corresponds to a song. This volatile data may also indicate an audio quality level.

This auxiliary data may be remanent data, i.e. data that has a longer lifetime. Such data may be recovered from a dedicated server; it may correspond to the logo of a radio station or a television channel, program listings, artist biographies, concert dates, video clips, etc.

Once auxiliary data has been recovered for each data stream as previously explained, selection assistance information to be displayed for each data stream is then determined in a step 12.

This selection assistance information may be linked to the data stream for which it is intended in a step 13. Finally, in a step 14, data streams linked in this way to the selection assistance information in step 13 are transmitted to the receiver device, which displays the selection assistance information at the location on its screen intended for the data stream to which it is linked.

Note here that the processor unit may be either colocated with the receiver device or located in a server for effecting the steps of the method of one implementation of the present invention on behalf of a plurality of receiver devices.

Thus the user may view displayed on the screen of the receiver device respective selection assistance information for the various received data streams.

FIG. 2 shows a set 20 of functions that enable implementation of a selection assistance method of one implementation of the present invention.

This set 20 of functions receives as input a plurality of dedicated auxiliary data streams. It is a simple matter to take also into account auxiliary data included directly in data streams.

A function set 20 of this kind includes an auxiliary data selection function 21. This auxiliary data selection function selects data as a function of objective selection criteria, i.e. criteria such as a valid digital format, for example the mp3 digital format, or a received dedicated stream quality level. There may equally be selected at this stage auxiliary data that is not contrary to a charter rejecting racist or insulting content.

Here it is equally possible to take into account subjective selection criteria of a user or users, such as keywords supplied by a user. A database 204 may be used to store user profiles indicating in particular such “keyword” selection criteria.

The selected auxiliary data may be updated on expiry of a timer.

This overall processing function 22 is shown in detail in FIG. 3. An overall function of this kind receives the selected auxiliary data and executes a decoding step 32 that may include decrypting 32 the auxiliary data concerned and sorting it as a function of its type. Thus auxiliary data may be obtained on exit from the step 32 decrypted and sorted according to a data stream ‘d’ corresponding to text, an ‘audio’ sound data stream, for example music or a sound track, and a ‘video’ stream such as a video clip, for example.

The decoded auxiliary data then undergoes filtering in a step 33. This filtering in particular suppresses certain indications, such as those relating to advertising or technical information.

The filtered auxiliary data then undergoes a formatting step 34. This formatting step 34 may include:
conversion to a digital format intended for playing back the streams;
possibly translation of a text or a sound track; or
audio signal processing such as equalization or video signal processing such as contrast adjustment.

Recognition services offered by a recognition server may also be used. This server may in particular effect voice recognition to determine the name of a person from their voice or to recognize music by determining in particular the name of the song or the artist, or any other recognition option. Transmitting some of this auxiliary data at least to a recognition server during the filtering or formatting step may be envisaged.

There follows a linking function 23 adapted to link remanent auxiliary data with volatile auxiliary data associated with the same data stream. The auxiliary data linked in this way may thereafter be synchronized with the associated data stream.

It should be noted that it is possible to implement a selection assistance method of one implementation of the present invention entirely on the basis of auxiliary data that is contained directly in the corresponding data stream. No synchronization between the auxiliary data and the corresponding data stream is then required.

If the received data stream corresponds to a video with no soundtrack, having the selected auxiliary data correspond to a soundtrack may be envisaged, for example. It is then necessary to synchronize the soundtrack with the video.

Auxiliary data supplied by a multimedia recognition server may optionally be added to the auxiliary data selected for a data stream. The data stream concerned is then supplied to the recognition server, which responds by sending additional selection assistance information.

The linking function 23 of one implementation of the present invention is shown in detail in FIG. 4.

This linking function 23 thus receives as input the auxiliary data available on exit from the overall processing function 22 shown in FIG. 3. Thus here the auxiliary data is received in the form of data streams that are sorted according to their type, text, audio, or video. Some of these sorted data streams are thereafter linked to some of the data streams.

A list 41 of data streams 411 to 413 shows either all the data streams received by the processor unit or data streams chosen beforehand by the user as being their favorite data streams. In other words, the user may preselect some data streams, for example by choosing radio stations they prefer or their preferred television channels.

This linking corresponds in fact to associating selection assistance information streams that may be of different types but that have some consistency with the data streams to which they are to be linked. Accordingly, the consistency of the data stream and the selection assistance information linked to it may rely on semantic or temporal consistency. For example, a biography in the form of a text document or a video relating to a guest may be associated with a data stream corresponding to a radio transmission during which the guest speaks. When a radio station that is declared a favorite of the user's profile is broadcasting a song, the auxiliary data linked to the data stream broadcast by that radio station may be text data indicating in particular the title of the song and the name of the artist, with additional auxiliary data corresponding to a video clip of the song currently being broadcast.

In the above situation, this linking function is associated with a synchronization function to synchronize the video clip with the song being broadcast.

A user interface function 26 then receives the data streams linked to the selection assistance information 41 on exit from the linking function 23 and displays on the screen of the receiver device at least some of the selection assistance information linked to the data stream concerned.

If the receiver device has a screen that is small compared to the selection assistance information to be displayed, there may be provision for a scrolling display, for example a moving stripe.

In one implementation of the present invention, a linking function is provided offering interactivity between different users of receiver devices of one embodiment of the present invention. This interactive linking function is shown in FIG. 5. Here the linking function 23 shown in FIG. 4 is additionally adapted to receive data streams from any terminal. To be more precise, this interactivity enables the various users of a receiver device of one embodiment of the present invention to communicate with each other in relation to the data stream concerned.

Thus it is possible for a user ‘usr₁’ or ‘usrⱼ’ to transmit information they have chosen to other users in a user stream 51 or 52. The expression ‘user stream’ means a stream sent from any terminal, for example from a mobile telephone, to which user information is transmitted, i.e. information relating to persons who view or listen to some of the data streams considered here. This information transmitted in user streams may be news on an artist such as concert dates or an opinion given on the audio and/or video content being broadcast. There is no limit on the type of information for a data stream that a user may send via a user stream.

Thus, in one implementation of the present invention, unlike the auxiliary data streams linked as a function of consistency criteria with the data streams received simultaneously in the processor unit, these user streams are intended for one or more respective particular data streams. For example, the users ‘usr₁’, ‘usrⱼ’ transmit information to be linked with the linked data stream 413. The user streams may therefore indicate a data stream to which they must be linked and the user stream is then linked to the indicated data stream for all the receiver devices receiving it. Alternatively, user groups may be created within which interactivity is possible. Under such circumstances, if a user stream intended to be linked to a particular data stream is received from a user of the same group as the user who receives it, then the user stream is linked to that particular data stream; in the contrary situation, i.e. if the user transmitting the user stream does not belong to the same user group as the user who receives it, the user stream is ignored and is not linked to the particular data stream.

Interactivity can allow a multitude of services to be implemented. Interactivity can in particular be used for dedications that are displayed on the screen of the receiver device at the place corresponding to the data stream with which the dedication is associated. It may also be used to comment on television or radio programming.

It should be noted that all these functions shown in FIGS. 2, 3, 4, and 5 may advantageously be implemented in different locations. There is no limitation on the location of these functions. All these functions may be implemented in the receiver device.

All these functions 20 may equally be located on a server that receives the data streams and the auxiliary data streams and transmits the linked data streams obtained to the various receiver devices.

The server is then able to store one or more user profiles for each receiver device, a user profile of this kind indicating in particular a list of the favorite data streams of the user concerned. The server is then in a position to provide the user with their favorite data streams linked to the auxiliary data as explained above.

It is equally easy to envisage locating some functions on the server in order to pool them and others in the receiver devices. It is easy to set up any spatial configuration of these functions enabling the implementation of a stream selection assistance method.

FIG. 6 shows a user interface displayed on the screen of the receiver device of one embodiment of the present invention in its application to radio station selection. It is a simple matter to deduce from this an application suitable for television channels. A screen 61 of the receiver device includes five separate parts 61-65. In each of these parts the following selection assistance information is shown:
the logo of the corresponding radio station;
the name of that radio station: ‘radio 1’, ‘radio 2’, ‘radio 3’, ‘radio 4’, ‘radio 5’;
the title ‘prg’ of the song or show being broadcast;
the name ‘artist’ of the artist; and
with interactivity, comments from other users received via user streams as described above and here displayed to the user in the form of stars.

FIG. 7 shows a processor unit of one embodiment of the present invention. This processor unit 71 includes:
a receiver unit 72 adapted to receive simultaneously a plurality of data streams 702 and auxiliary data respectively associated with said data streams;
a determination unit 73 adapted to determine on the basis of the received auxiliary data selection assistance information to be displayed for each data stream;
a linking unit 74 adapted to link said data streams with the selection assistance information respectively determined; and
a transmission unit 75 adapted to transmit to the receiver device said data streams linked to the selection assistance information.

In one embodiment of the present invention, the processor unit 71 further includes an interface 703 with a data stream recognition server to which it sends a data stream, from which it receives additional selection assistance information, and in which said additional selection assistance information is linked to said data stream.

FIG. 7 also shows a receiver device 704 of one embodiment of the present invention. This receiver device includes:
a screen 60;
a display unit 706 for displaying selection assistance information on a screen;
a receiver unit 707 for receiving a data stream selection command based on the selection assistance information displayed on the screen; and
a play-back unit 708 for playing back the selected data stream.

The processor unit may be in the receiver device of the user, and all the functions 20 are then implemented in the receiver device.

Alternatively, the processor unit 71 may correspond to a server that supplies to a plurality of receiver devices 704 data streams linked to selection assistance information.

In the former situation the transmission between the processor unit and the receiver device is internal while in the latter situation it is external.

With external transmission, i.e. when the processor unit corresponds to a server, any type of transmission may be used, notably wireless transmission.

1. A method of assisting the selection of a data stream to be played back in a receiver device from a plurality of data streams received by the receiver device, the receiver device including a screen, said method comprising the following steps executed in a processor unit:
a) simultaneously receiving a plurality of data streams and auxiliary data respectively associated with said data streams;
b) determining, based on the received auxiliary data selection, assistance information to be displayed for each data stream;
c) linking the data streams with the selection assistance information respectively determined; and
d) transmitting to the receiver device the data streams linked to said selection assistance information;
auxiliary data being also received in said step a) in at least one user stream, said user stream being dynamically associated with a data stream.

2. The method according to claim 1, wherein the auxiliary data is received in at least one of the data streams and dedicated auxiliary data streams.

3. The method according to claim 1, wherein the processor unit is in the receiver device.

4. The method according to claim 1, wherein the processor unit determines the selection assistance information for a data stream from said received auxiliary data taking into account at least one criterion specific to at least one of the auxiliary data and a user profile.

5. The method according to claim 1, further comprising before the step c) the following steps executed in the processor unit for a data stream:
sending the data stream to a data stream recognition server; and
receiving from said data stream recognition server additional selection assistance information linked to said data stream.

6. The method according to claim 1, wherein in the step c) selection assistance information is linked with a data stream as at least one of a function of semantic and temporal consistency criteria.

7. (canceled)

8. The method according to claim 1, further comprising the following steps executed in the receiver device:
1) displaying the selection assistance information on the screen;
2) receiving a data stream selection command based on the displayed selection assistance information; and
3) playing back the selected data stream.

9. A processor unit adapted to offer assistance with the selection of a data stream to be played back in a receiver device from a plurality of data streams received by the receiver device, the processor unit comprising:
a receiver unit adapted simultaneously to receive a plurality of data streams and auxiliary data respectively associated with said data streams;
a determination unit adapted to determine, based on the basis of the received auxiliary data selection assistance information to be displayed for each data stream;
a linking unit adapted to link the data streams with the selection assistance information respectively determined; and
a transmission unit adapted to transmit to the receiver device the data streams linked to said selection assistance information.

10. The processor unit according to claim 9, further comprising an interface with a data stream recognition server to which it sends a data stream and from which it receives additional selection assistance information linked to said data stream.

11. A receiver device adapted to offer assistance with the selection of a data stream and to play back a data stream selected from a plurality of data streams received by the receiver device, said receiver device comprising:
a screen;
a display unit for displaying the selection assistance information on a screen;
a receiver unit adapted to receive a data stream selection command based on the selection assistance information displayed on the screen; and
a play-back unit adapted to play back the selected data stream.

12. The receiver device according to claim 11 comprising the processor unit adapted to offer assistance with the selection of a data stream to be played back in a receiver device from a plurality of data streams received by the receiver device, the processor unit comprising:
a receiver unit adapted simultaneously to receive a plurality of data streams and auxiliary data respectively associated with said data streams;
a determination unit adapted to determine, based on the received auxiliary data selection assistance information to be displayed for each data stream;
a linking unit adapted to link the data streams with the selection assistance information respectively determined; and
a transmission unit adapted to transmit to the receiver device the data streams linked to said selection assistance information.

13. A computer comprising a receiver device according to claim 11.

14. A non-transitory computer program productrising instructions for executing the method according to claim 1 when that program is executed by a processor.

15. A storage medium on which is stored the computer program according to claim 14.

16. A computer comprising a receiver device according to claim 12.
